(19) United States
(12) Patent Application Publication
(10) Pub. No.: US 2012/0184340 A1
(43) Pub. Date: Jul. 19, 2012

(54) VIRTUAL GOLF SIMULATION APPARATUS AND METHOD

(75) Inventor: Cheol Ho Jang, Incheon (KR)

(73) Assignee: GOLFZON CO., LTD., Daejeon (KR)

(21) Appl. No.: 13/498,691

(22) PCT Filed: Sep. 28, 2010
(86) PCT No.: PCT/KR2010/006562

§ 371 Date: Mar. 28, 2012

(30) Foreign Application Priority Data
Sep. 29, 2009 (KR) 1020090092613

(51) Int. Cl. A63F 13/00

(52) U.S. Cl. 463/2

(57) ABSTRACT

A virtual golf simulation apparatus and method are provided. In the apparatus and method, a golfer is allowed to selectively or arbitrarily set a hole-cup position on a green during a simulation procedure of a virtual golf course and a hole-cup is generated at the set position to provide virtual golf simulation environments meeting various needs of golfers who enjoy virtual golf games while arousing their interest. The virtual golf simulation apparatus for a golf course includes a setting unit for setting a hole-cup position on a putting green and an image processing unit for generating and rendering a hole-cup at the set hole-cup position on the putting green.

### TECHNICAL FIELD

The present invention relates to a virtual golf simulation apparatus and method, and more particularly to a virtual golf simulation apparatus and method in which a virtual golf course is rendered (or visualized) and simulated and a track of a golf ball struck by a user, i.e., a golfer, is simulated in the virtual golf course.

### BACKGROUND ART

Golf is a game that is played by striking a golf ball from a tee box to a green to sink it into a hole-cup. Especially, putting on a green is a very challenging and difficult part of the game since the golfer should correctly judge the lie on the green and strike the golf ball with accurate force, direction, and the like.

The position of the hole-cup is very important for golfers when putting since strategies required for each hole such as approach and putting style strategies vary depending on where the hole-cup is located on the putting green.

For example, when the golfer hits an approach shot when the hole-cup is located near a rear edge of the green, the golfer should very carefully strike the golf ball since the ball may easily cross the green.

A virtual golf simulation apparatus includes a screen installed indoors for displaying a virtual golf course. When the user strikes a golf ball toward the screen, the virtual golf simulation apparatus senses the speed, direction, and the like of the golf ball and displays the movement of the golf ball on the screen. The virtual golf simulation apparatus allows the user to play through the virtual golf course with a sense of realism as though they were playing a real golf course while striking the golf ball in the same manner as when striking a golf ball on a driving range.

Special functions, which cannot be implemented during a real round of golf, can be performed in a virtual round of golf provided by the virtual golf simulation apparatus. Such functions need to provide convenience to golfers, who enjoy virtual golf games, and to arouse their interest.

### DISCLOSURE OF INVENTION

### Technical Problem

Therefore, the present invention has been made in view of the above circumstances, and it is an object of the present invention to provide a virtual golf simulation apparatus and method in which a golfer is allowed to selectively or arbitrarily set a hole-cup position on a green during a simulation procedure of a virtual golf course and a hole-cup is generated at the set position to provide virtual golf simulation environments meeting various needs of golfers who enjoy virtual golf games while arousing their interest.

### Solution to Problem

In accordance with an aspect of the present invention, the above and other objects can be accomplished by the provision of a virtual golf simulation apparatus, the apparatus including a setting means which sets a hole-cup position on a putting green in an virtual golf simulation image, and an image processing means which generates and render a hole-cup at the set hole-cup position on the putting green.

In accordance with another aspect of the present invention, there is provided a virtual golf simulation apparatus, the apparatus including a storage unit which stores information regarding hole-cup position setting and putting green information in an virtual golf simulation image, a manipulation means which performs a manipulation for arbitrarily or selectively setting a hole-cup position on a putting green based on the information regarding the hole-cup position stored in the storage unit, and an image processing unit which generates and outputs a putting green and an image associated with hole-cup position setting and generating and rendering a hole-cup at the set position on the putting green based on the information stored in the storage unit.

In accordance with another aspect of the present invention, there is provided a virtual golf simulation method, the method including displaying image information for setting a hole-cup position on a putting green in an virtual golf simulation image, setting a position at which a hole-cup is to be generated on the putting green, and generating a hole-cup at the set position on the putting green.

### Advantageous Effects of Invention

In the virtual golf simulation apparatus and method according to the present invention, a golfer can selectively or arbitrarily set a hole-cup position on a green during a simulation procedure of a virtual golf course and a hole-cup is generated at the set position, thereby providing virtual golf simulation environments meeting various needs of golfers who enjoy virtual golf games while arousing their interest.

### BRIEF DESCRIPTION OF DRAWINGS

The above and other objects, features and other advantages of the present invention will be more clearly understood from the following detailed description taken in conjunction with the accompanying drawings, in which:

FIG. 1 illustrates a screen golf system which employs a virtual golf simulation apparatus according to an embodiment of the present invention;

FIG. 2 is a block diagram illustrating a control system of the virtual golf simulation apparatus according to the embodiment of the present invention;

FIG. 3 illustrates the screen golf system which employs the virtual golf simulation apparatus according to an embodiment of the present invention having another exemplary manipulation means;

FIG. 4 illustrates a method for setting a position at which a hole-cup is to be generated on a green in the virtual golf simulation apparatus according to the embodiment of the present invention;

FIG. 5 illustrates an example of a selection menu used for selecting a green and a hole-cup position in the virtual golf simulation apparatus according to the embodiment of the present invention;

FIG. 6 illustrates another method for setting a position at which a hole-cup is to be generated on a green in the virtual golf simulation apparatus according to the embodiment of the present invention;

FIG. 7 is a flow chart illustrating a virtual golf simulation method according to an embodiment of the present invention; and

FIGS. 8(a) to 8(e) illustrate an exemplary hole-cup generation method used in the virtual golf simulation method according to the embodiment of the present invention.

### BEST MODE FOR CARRYING OUT THE INVENTION

Embodiments of a virtual golf simulation apparatus and method according to the present invention will now be described in more detail with reference to the drawings.

The virtual golf simulation apparatus and method according to the present invention can be implemented in a variety of forms and can be typically applied to a so-called screen golf system.

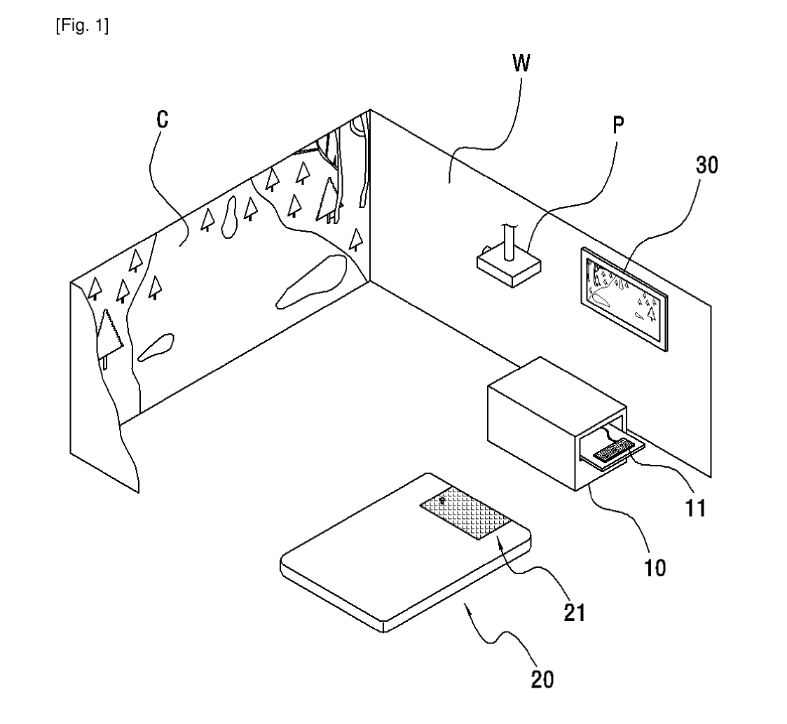

FIGS. 1 and 3 illustrate an example in which the virtual golf simulation apparatus and method according to the present invention are applied to a screen golf system. Although not illustrated, the present invention can also be applied to any other type of system or apparatus which simulates and renders (or visualizes) a virtual golf course and simulates and renders a virtual golf ball.

The example in which the virtual golf simulation apparatus and method according to the present invention are applied to a screen golf system is described below in detail with reference to FIGS. 1 to 3.

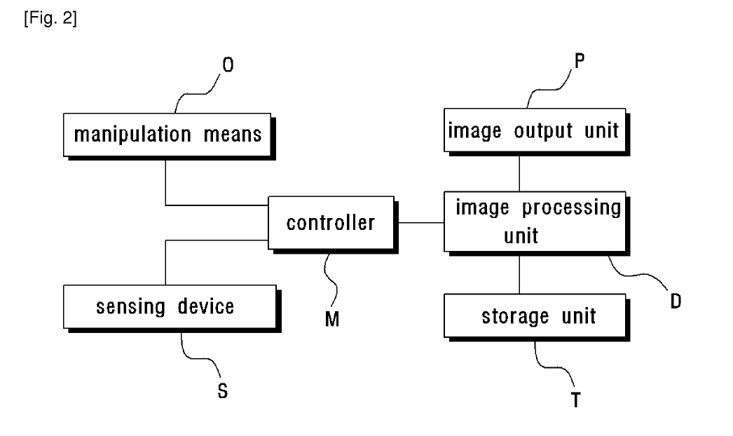

As shown in FIGS. 1 and 2, the virtual golf simulation apparatus according to an embodiment of the present invention includes a swing plate 20, a sensing device S, an image output device P, and a simulator. The image output device P outputs an image to a screen C provided at a front side. The simulator performs storage, processing, and the like on all data required for virtual golf simulation. The simulator is provided in a protective housing 10 as shown in FIG. 1.

The simulator may include an image processing unit D, a storage unit T, and a controller M.

The storage unit T stores all data required for virtual golf simulation, including data regarding virtual golf courses. The image processing unit D processes data of all virtual golf simulation related images stored in the storage unit T, including virtual golf course related images, golf ball movement images, and images for menu selection.

The controller M performs a variety of calculations for virtual golf simulation, overall control of the components, and the like.

Specifically, when a golfer strikes a golf ball toward the screen C on the swing plate 20, the sensing device S senses the striking and provides the sensed signal to the controller M and the controller M then provides the sensed signal to the image processing unit D. The image processing unit D retrieves golf simulation image information such as a movement image of the golf ball from the storage unit T and creates a corresponding image taking into consideration the movement pattern of the golf ball. The golf game is performed through virtual simulation while projecting the created image onto the screen C through the image output device P.

Although not shown in detail in FIG. 1, the sensing device S (see FIG. 2) may be implemented by infrared light emitting/receiving sensors installed at the side of the swing plate 20 or may be implemented by a camera sensor mounted on the ceiling, a wall, or the like and may also be implemented by any other type of sensor.

The virtual golf simulation apparatus according to this embodiment also includes a manipulation means O that allows the user to perform manipulations for settings such as system settings or various settings for playing a golf game.

In FIG. 1, a keyboard 11 provided on the protective housing 10 including the simulator is shown as an example of the manipulation means O. The touch screen 30 provided on a side wall W may also be provided as an example of the manipulation means O. Although not illustrated, a mouse device is preferably provided together with the keyboard 11.

Although not illustrated, a remote control (not shown) may be provided as the manipulation means O to perform manipulation associated with virtual golf simulation while directly communicating with the simulator or directly communicating with the touch screen.

FIG. 3 illustrates a key operating unit 22 provided on the swing plate 20 as an example of the manipulation means.

Since a golfer standing on the swing plate 20 cannot conveniently manipulate the keyboard 11 or the touch screen 30 shown in FIG. 1, the key operating unit 22 is preferably provided on the swing plate 20 so as to allow a golfer who is ready to swing to easily perform manipulation for virtual golf simulation setting.

A keypad (not shown) may also be provided near the swing plate 20 as a device enabling the golfer to perform manipulation for virtual golf simulation setting. The keypad (not shown) may be selectively provided in combination with the keyboard 11 or with the touch screen 30. Forward, backward, left, and right navigation keys may be provided on the keypad to allow the golfer to easily adjust various settings or to easily perform aiming in the virtual golf simulation procedure.

The virtual golf simulation apparatus according to the present invention basically includes any means for allowing a hole-cup position to be arbitrarily or selectively set by a user, i.e., by a golfer, so that a hole-cup is generated and rendered at the arbitrarily or selectively set position on a putting green in a virtual golf course.

Respective hole-cup positions of holes may be collectively set in a selection menu before a virtual round of golf starts and the hole-cup position of each hole may also be individually set during a virtual round of golf at the hole.

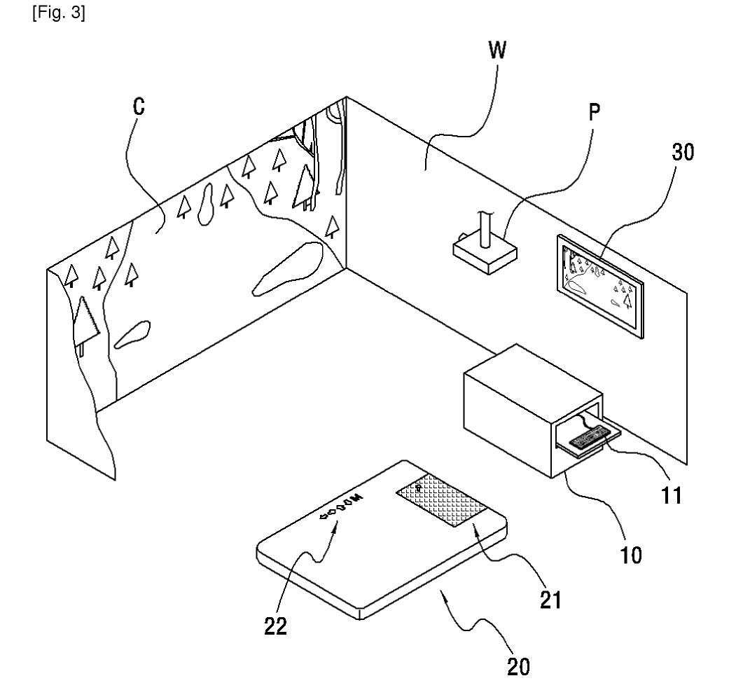

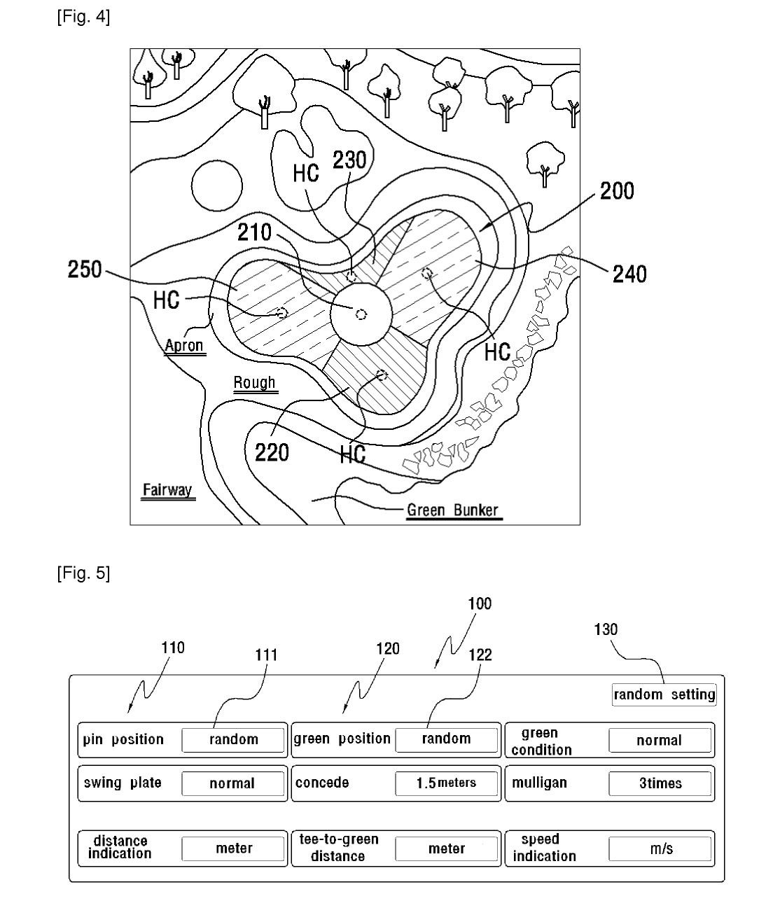

FIG. 4 illustrates an example in which the user selects the position of a hole-cup on a putting green of a virtual golf course.

As shown in FIG. 4, the virtual golf course may be provided as images of a fairway, a rough, a green bunker, an apron, a putting green 200, and the like. The images may be implemented as a different golf course according to the characteristics of each hole.

The putting green 200 may be divided into a middle pin region 210, a front pin region 220, a rear pin region 230, a right pin region 240, and a left pin region 250.

A center region of the putting green 200 may be set as the middle pin region 210 and the area surrounding the middle pin region 210 may be divided into the front pin region 220, the rear pin region 230, the right pin region 240, and the left pin region 250.

The user may select one of the middle pin region 210, the front pin region 220, the rear pin region 230, the right pin region 240, and the left pin region 250 through the manipulation means O (see FIG. 2) and a hole-cup HC is generated at a preset position in the selected region.

Since all holes have different greens, some of the regions may be set to be selectable or may be set to be locked according to the green condition of each hole. This setting is determined according to a rule preset in the controller.

The position of the hole-cup HC on the putting green 200 may be individually set on each hole in a golf course that is currently being played or may be collectively selected for all holes during initial system setting.

The middle pin region 210, the front pin region 220, the rear pin region 230, the right pin region 240, and the left pin region 250 may be indicated by flags having different colors.

FIG. 5 illustrates an example of a selection menu that allows the user to set the position of a hole-cup on a screen.

As shown in FIG. 5, a pin (hole-cup) position setting tab 110 and a green position setting tab 120 are displayed in the selection menu 100 and various other tabs may also be provided in the selection menu 100.

An option display portion for pin position 111, which allows the user to select one of a middle pin, a front pin, a rear pin, a right pin, a left pin, and a random (a random selected one of the pins), is displayed in the pin position setting tab 110 and an option display portion for green position 122, which allows the user to select one of a left green, a right green, and a random (a random selected one of the greens), is displayed in the green position setting tab 120.

The green position selection tab is used to select a green from a hole having a plurality of (optional) greens.

Typically, two greens, which are referred to as “left and right greens”, are displayed on one hole. When the two greens are displayed, the green position selection tab is used to select one of the two greens to play the game.

The random green position selection function is used to allow the system to automatically select and set one green in a random manner.

The random pin position selection function is used to allow the system to automatically select and set one of the middle, front, rear, right, and left pins in a random manner.

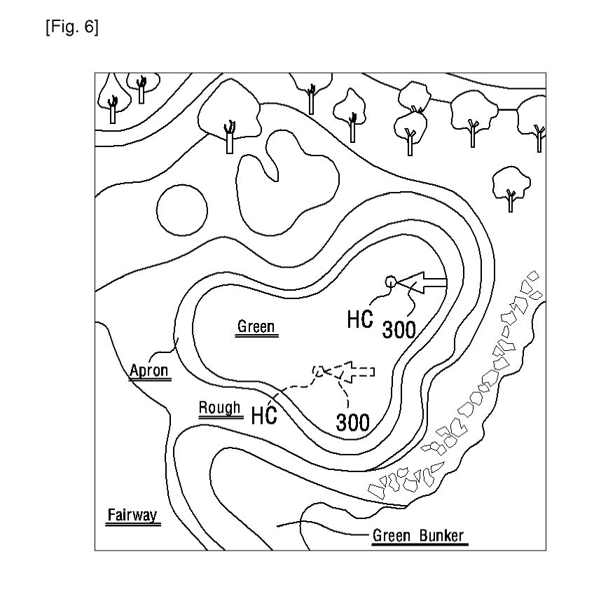

FIG. 6 illustrates a virtual golf simulation method according to another embodiment of the present invention in which the user directly specifies the position of a hole-cup on a putting green.

When a putting green 200 is displayed, a pointer 300 is displayed together with the putting green 200 as shown in FIG. 6. The user can generate a hole-cup HC at a desired position by moving the pointer 300 through the manipulation means O (see FIG. 2).

The user can arbitrarily specify (that is designation by the user to specify) the position of the hole-cup using a keyboard, a key operating unit, a touch screen, or a remote control and can also arbitrarily specify the position of the hole-cup using a mouse.

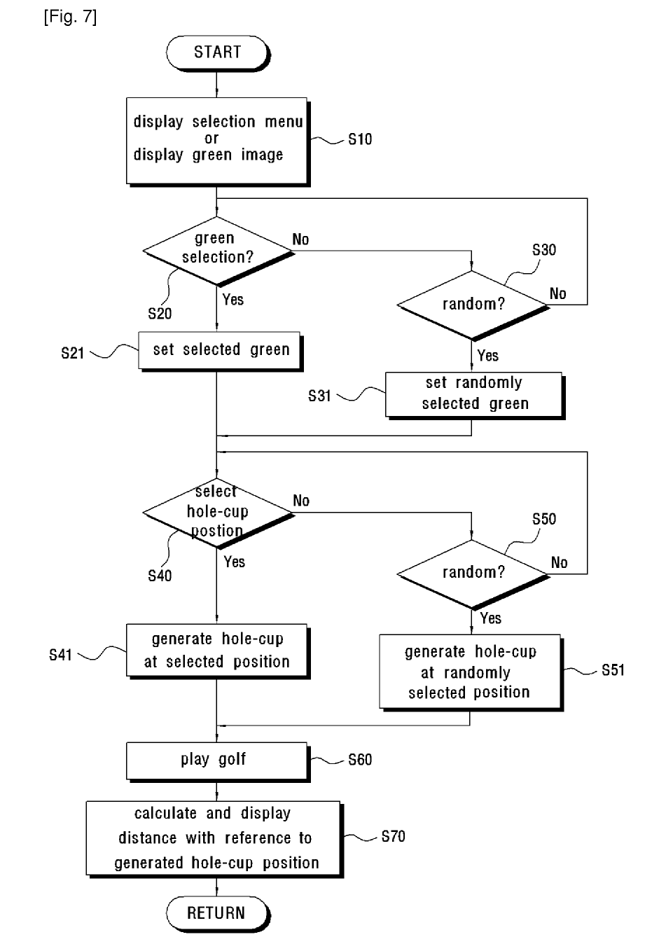

A virtual golf simulation method according to an embodiment of the present invention is described below with reference to FIG. 7.

The procedure shown in FIG. 7 may be performed in an initial system setting procedure of a virtual round of golf and may also be individually performed at each hole in the virtual round of golf.

First, a putting green image or a selection menu is displayed for hole-cup position setting (S10). Here, when a putting green image is displayed, the putting green image may be displayed together with a middle pin region, a front pin region, a rear pin region, a right pin region, and a left pin region or the putting green image alone may be displayed to allow the user to arbitrarily set the hole-cup position.

On the other hand, when a plurality of (putting) greens is displayed, the user selects a green to be played (S20). When the user selects one of the plurality of greens, the selected green is set as a green where a hole-cup is to be generated (S21). One of the plurality of greens may also be randomly selected (S30). When one of the plurality of greens is randomly selected, the randomly selected green is set as a green where a hole-cup is to be generated (S31).

After a green to be played is selected, a hole-cup position is set on the selected green. The user may select one of a plurality of preset hole-cup positions (S40) and may also designate to specify a hole-cup position (i.e., may also place a hole-cup anywhere on the putting green). When the user selects a random selection function (S50), the system randomly sets a hole-cup position on the green.

After the hole-cup position is selected or specified, a hole-cup is generated at the set position (S41). Alternatively, a hole-cup is generated at the randomly selected position (S51).

After the hole-cup position is set and the hole-cup is generated as described above, the golf game is played (S60). While the golf game is played, values such as a tee-to-green distance of each hole and a remaining distance after each stroke are calculated with reference to the position of the generated hole-cup and the calculated values are displayed (S70).

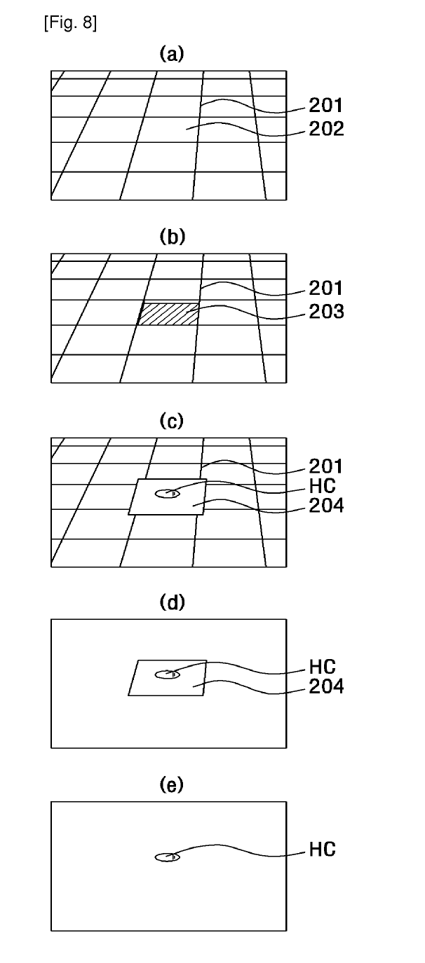

An exemplary procedure in which a hole-cup is generated at a set position is described below with reference to FIG. 8.

A green is divided into sections in a grid (or mesh) form 201 as shown in FIG. 8(a) and a section 202 including a position at which a hole-cup is generated is removed from the green as shown in FIG. 8(b). After the section 202 is removed, an empty section 203 remains on the green.

A section 204 in which a hole-cup HC is generated is arranged in the empty section 203 as shown in FIG. 8(c). Here, the size of the section 204 where the hole-cup HC is generated is preferably slightly greater than that of the removed section 203 as shown in FIG. 8(c).

Edge portions of the section 204 in which the hole-cup HC is generated are corrected according to surrounding topography as shown in FIG. 8(d). After the edge portions of the section 204 are corrected, a hole-cup is generated on the green as shown in FIG. 8(e).

The hole-cup generation method is only an example of the virtual golf simulation method according to the present invention and the virtual golf simulation apparatus according to the present invention includes any method for generating a hole-cup at a position set on a green.

### MODE FOR THE INVENTION

Various embodiments of a virtual golf simulation apparatus and method according to the present invention have been described in the above best mode section.

### INDUSTRIAL APPLICABILITY

The virtual golf simulation apparatus and method according to the present invention may be widely used in golf-game-related or simulation-related industrial fields since the apparatus and method can provide virtual reality golf game environments which meet various user needs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-21. (canceled)

22. A virtual golf simulation apparatus comprising:
a setting means which displays one of a selection menu for selecting a position, an image for selecting a position on a putting green, and an image for designating a position on a putting green, and which sets a selected or designated position to a hole-cup position on the putting green in a virtual golf simulation image; and
an image processing means which generates and images a hole-cup at the set hole-cup position on the putting green.

23. The virtual golf simulation apparatus according to claim 22, wherein the setting means comprises:
a menu displaying means which displays the selection menu associated with a hole-cup position on the putting, green for a specific hole-cup position on the selection menu to be selected by user's manipulation.

24. The virtual golf simulation apparatus according to claim 22, wherein the setting means comprises:
a displaying means which displays a putting green and the image for selecting a position displaying the putting green divided into a plurality of regions for selecting the hole-cup position by user's manipulation.

25. The virtual golf simulation apparatus according to claim 22, wherein the setting means comprises:
a displaying means which displays a putting green and the image for designating a position to specify a position at which a hole-cup is to be generated on the putting green by user's manipulation.

26. The virtual golf simulation apparatus according to claim 22, further comprising:
a selection setting means for selecting a putting green to be played from among a plurality of putting greens, wherein the selection setting means is configured to set the selected putting green to be played if a putting green: is selected among the plurality of putting greens or randomly selected.

27. The virtual golf simulation apparatus according to claim 23, wherein the setting means sets the putting green to be divided into at least two of a middle pin region, a front pin region, a rear pin region, a right pin region, and a left pin region, and the menu displaying, means is configured to display the selection, menu for allowing one of the two divided regions to be selected by a user or to be randomly selected, and
wherein the setting means is configured to generate a hole-cup at a predetermined position in a selected region through the menu displaying means.

28. The virtual golf simulation apparatus according to claim 24, wherein the setting means sets the putting green to be divided into at least: two of a middle pin region, a front pin region, a rear pin region, a right pin region, and a left pin region, and the displaying means is configured to display the regions on the putting green for allowing one of the regions on the putting green to be selected by a user, and
wherein the setting means is configured to generate a hole-cup at a predetermined position in a selected region through the displaying means.

29. The virtual golf simulation apparatus according to claim 22, further comprising a manipulation means which provides a manipulation on the setting means for selecting a position at which a hole-cup is to be generated on the putting green.

30. The virtual golf simulation apparatus according to claim 29, wherein the manipulation means includes a means for rendering a pointer for selecting a position at which a hole-cup is to be generated on the putting green.

31. The virtual golf simulation apparatus according to claim 27, wherein the manipulation means includes at least one of a keypad provided near a swing plate, a key operating unit provided on the swing plate, a touch screen, and a keyboard for inputting setting information.

32. A virtual golf simulation method comprising:
displaying a selection menu associated with the hole-cup position on the putting green;
setting, a specific position corresponding to an item selected in the selection menu as the hole-cup position; and
generating a hole-cup at the set position on the putting green.

33. The virtual golf simulation method according to claim 32, wherein the step of displaying a selection menu comprises,
dividing a putting green into at least two of a middle pin region, a front pin region, a rear pin region, a right pin region, and a left pin region and displaying a selection menu for allowing one of the two divided regions to be selected by a user or to be randomly selected, and
the step of setting a specific position comprises,
setting a preset position in a region corresponding to an item selected in the selection menu as the hole-cup position.

34. The virtual golf simulation method according to claim 33, wherein the step of setting a specific position further comprises,
indicating a hole-cup position in a selected region by a flag having a color different from a flag of another region's hole-cup position.

35. The virtual golf simulation method according to claim 32, wherein the step of generating the hole-cup comprises:
dividing the putting green into a plurality of sections in a grid or mesh form;
removing a set section from the plurality of sections; and
arranging a section in which a hole-cup is generated in an area corresponding to the removed section.

36. The virtual golf simulation method according to claim 32, further comprising calculating a tee-to-green distance and a remaining distance of each hole according to the set hole-cup position.

37. A virtual golf simulation method comprising:
displaying a putting green;
displaying one of an image for selecting a position on the putting green and an image for designating a position on the putting green;
setting a position selected through the image for selecting or designated through the image for designating as the hole-cup position on the putting green; and
generating a hole-cup at the set position on the putting green.

38. The virtual golf simulation method according to claim 37, wherein the step of displaying the image for selecting a position on the putting green comprises,
dividing a putting green into at least two of a middle pin region, a front pin region, a rear pin region, a right pin region, and a left pin region and displaying the regions on the putting green for allowing one of the regions on the putting green to be selected by a user, and
the step of setting a position selected through the image for selecting comprises,
setting a predetermined position in a selected region as the hole-cup position.

39. The virtual golf simulation method according to claim 37, further comprising displaying, on the putting green, a plurality of sections in a grid or mesh form into which the putting green is divided,
wherein designation by a user to specify the position at which the hole-cup is to be generated comprises selecting one of the plurality of sections in the grid or mesh form.
